(19) United States
(12) Patent Application Publication
(10) Pub. No.: US 2026/0333554 A1
(43) Pub. Date: Oct. 22, 2026

(54) Subsurface Equipotential Grounding System

(71) Applicant: Jacob Downer, Middleton, ID (US)

(72) Inventor: Jacob Downer, Middleton, ID (US)

(21) Appl. No.: 19/719,776

(22) Filed: Jun. 25, 2026

Related U.S. Application Data
(63) Continuation of application No. 29/992,889, filed on Mar. 11, 2025, now Pat. No. D1142274.

(51) Int. Cl. H05F 3/02

(52) U.S. Cl. CPC H05F 3/025

(57) ABSTRACT

A grounding system for electrically grounding structures with voltage is disclosed in multiple embodiments. The system comprises a frame having front, back, and side portions coupled together to form top and bottom sides. A mesh structure is created by coupling a plurality of first members oriented in a first direction with perpendicular second members, with the mesh being coupled to the frame at one or more connection points. A grounding rod connects the mesh to the structure's ground. In a second embodiment, the system features at least one first rod extending from a first end through a patterned configuration of bends, including a first bend followed by a perpendicular extension to a second bend, and a horizontal extension that repeats to create multiple sections.

### CROSS REFERENCE TO RELATED APPLICATIONS

This application claims benefit from currently pending U.S. Design Patent Ser. No. 29/992,889 titled “Subsurface Equipotential Grounding System” and having a filing date of Mar. 11, 2025, all of which is incorporated by reference herein.

### FIELD OF THE INVENTION

The present invention relates generally to electrical grounding systems, and more particularly to an improved grounding system to provide consistent performance through a standardized grounding system.

### BACKGROUND OF THE INVENTION

Grounding systems are designed to place the worker at an equipotential zone (“EPZ”) that can protect the worker from electrical shock. This equipotential zone protects the worker from any possibility of current flowing across the worker's body. An EPZ mat bonds all conductive components together to an earthen ground that creates a predominant circuit wherein the voltage gained from the circuit is transferred to the EPZ mats where the electrical potential is equalized. So, when the worker stands on the EPZ mat the worker has the same electrical potential as the circuit.

The EPZ mat is usually connected to a ground grid to create a predominant circuit. EPZ grounding requires low impendence grounding to limit voltage rise and bonding to eliminate differences in potential. An EPZ Mat (Equipotential Zone) bonds all the conductive components to the earth ground to create a predominant circuit which can give the worker the same potential (voltage) when standing on the mat or the ground directly above the mat. The mat is connected to the ground grid and is connected to electrical equipment the worker may be operating or working on to keep the worker at the same voltage as the equipment being worked on whether that's 0 volts or 4000 volts, since electricity only flows if there is a difference, as such these mats are critical to keeping the worker safe.

Conventional electrical grounding systems have traditionally relied on simple conductive paths to direct unwanted electrical charges safely into the ground. These systems, while functional, have faced numerous challenges in modern applications where reliability, monitoring, and adaptability are increasingly critical. Traditional grounding systems typically consist of basic copper rods or plates laid into a hole and buried in soil, connected to structures through simple conductive cables or straps. These conventional approaches have several inherent limitations that the present invention addresses.

One significant challenge with existing grounding systems is the labor-intensive and time-consuming process of installing ground cables or straps into the soil. Traditional installation methods require careful manual measurement and placement to ensure optimal spacing between conductors for effective grounding performance. This process often involves extensive excavation, precise measuring, and meticulous installation procedures to maintain consistent conductor separation distances that maximize ground dissipation effectiveness. The difficulty in achieving and verifying proper spacing during installation can lead to suboptimal grounding performance and increased installation costs.

Furthermore, variations in installation techniques between different installers can result in inconsistent grounding effectiveness across different sites, even when using identical materials and specifications. Current methods lack standardized installation aids or mechanisms to ensure rapid, accurate placement of grounding conductors at optimal spacing intervals, making the installation process heavily dependent on installer expertise and subject to human error.

Therefore, there exists a need for a grounding system that significantly reduces installation time while ensuring optimal conductor spacing for maximum grounding effectiveness. The system should provide consistent and verifiable spacing during installation, eliminate the reliance on manual measurements, and minimize the potential for human error in conductor placement. Furthermore, there is a need for a standardized installation method that maintains uniform grounding performance regardless of installer expertise or site conditions

### SUMMARY OF THE INVENTION

Accordingly, the present invention provides for improved grounding systems for electrically grounding structures with voltage. In one embodiment, the grounding system comprises a frame constructed with a front end, back end, first side, and second side coupled together to form top and bottom sides. A mesh structure is formed by intersecting a plurality of first members oriented in a first direction with a plurality of second members oriented perpendicularly. This mesh is coupled to the frame at one or more connection points. A grounding rod having first and second ends completes the system, with the first end coupled to the mesh and the second end connected to the structure's ground.

In another embodiment, the grounding system features a geometric configuration comprising at least one first rod that extends from a first end through a series of bends, creating a repeating pattern. Specifically, the rod extends from the first end to a first bend, then perpendicular to a second bend, followed by a horizontal extension. This pattern repeats at least once to create multiple sections. The system includes a second rod extending near the first bend and coupled to the first rod, as well as a third rod extending from near the first end and similarly coupled. A grounding rod can be coupled to any of these components-the first rod, second rod, or third rod.

The system incorporates various innovative connection methods, including connection blocks with holes to accommodate multiple rods. These connections can be achieved through welding, crimping, or bonding. The components can be manufactured from various materials including wire mesh, flat steel, round copper, copper round bar, round steel, copper wire, or ground rod material. The connection blocks themselves may be constructed from copper or steel. A key feature of both embodiments is their flexibility in construction, allowing for either modular assembly using multiple welded sections or continuous rod construction. The system accommodates various installation requirements while maintaining effective grounding capabilities for voltage protection.

The systems represent significant improvements over conventional designs by providing enhanced structural integrity, installation flexibility, and reliable grounding performance for various applications.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of. . . “or” step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 shows an isometric view of the grounding mat system in accordance to one or more embodiments;

FIG. 2 shows an isometric view of the grounding mat system in accordance to one or more embodiments;

FIG. 3 shows an isometric view of the grounding mat system in accordance to one or more embodiments;

FIG. 4 shows an isometric view of the grounding mat system in accordance to one or more embodiments;

FIG. 5 shows an isometric view of another embodiment of the grounding mat system connected to a structure in accordance to one or more embodiments;

FIG. 6 shows an isometric top view of another embodiment of the grounding mat system in accordance to one or more embodiments;

FIG. 7 shows an isometric bottom view of another embodiment of the grounding mat system in accordance to one or more embodiments; and

FIG. 8 shows a bottom view of the grounding mat system in accordance to one or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

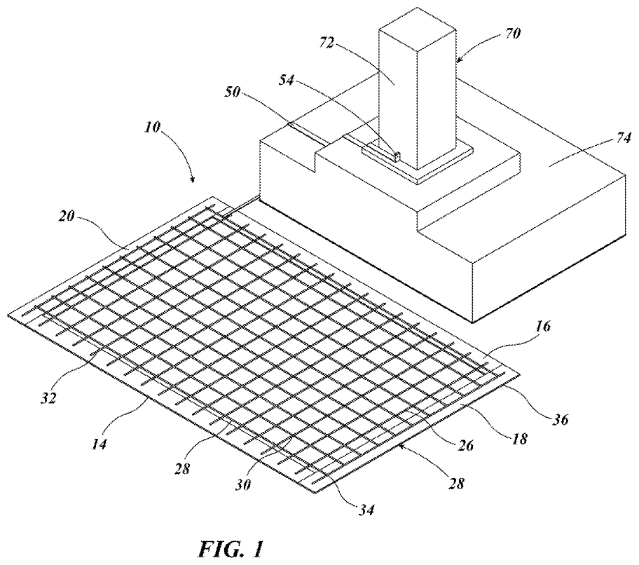

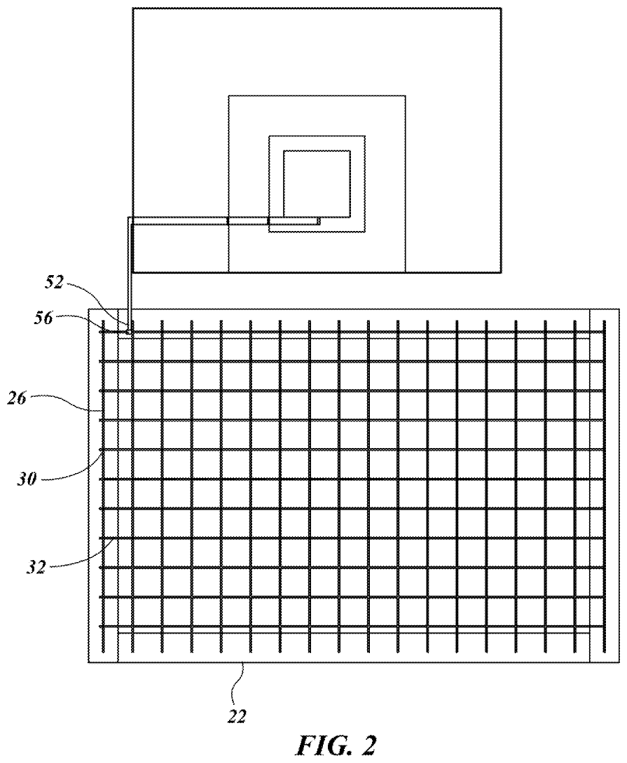

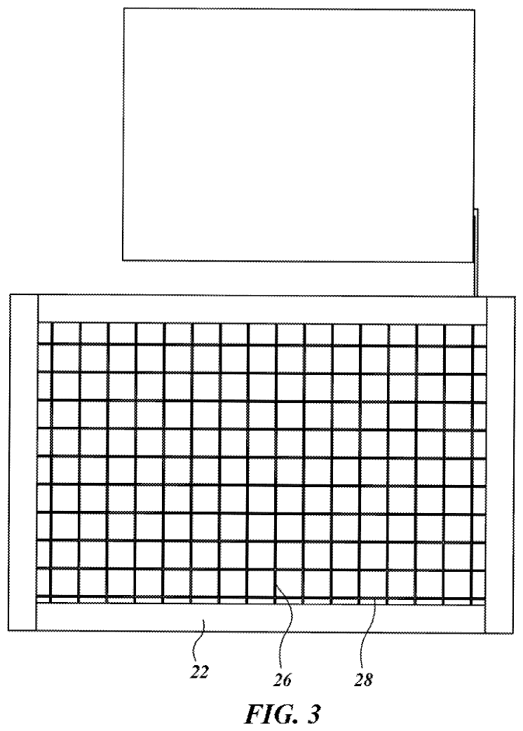

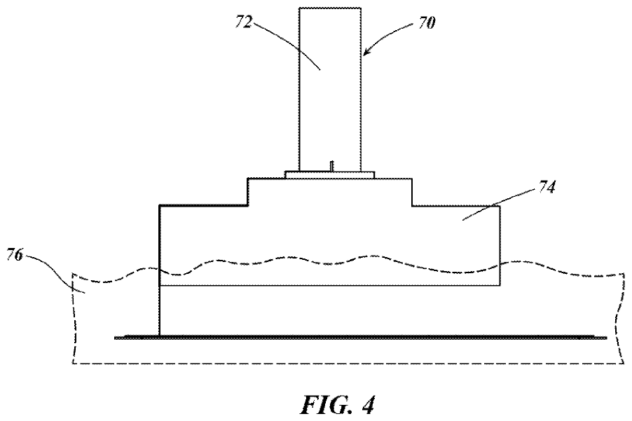

Referring initially to FIG. 1-4 , a grounding mat system for electrically grounding a structure 80 is shown generally at 10. The grounding mat system 10 can comprise a front member 14, back member 16, first side 18 and a second side 20 coupled together forming a frame 12 collectively defining a top side 22 and a bottom side 24. The front member 14 and the back member 16 can be substantially longer than the first side 18 and the second side 20 such as for example the front member and the back member can be seventy-two inches and the first side, and the second side can be forty-eight inches, thereby forming a six-foot by four-foot grounding area. In other embodiments, the front member 14 and the back member 16 can be such as, for example, at least 24 inches to 200 inches and even more preferably 48 inches to 100 inches and still more preferably 72 inches. These dimensional variations enable the grounding mat system to accommodate diverse installation requirements while maintaining effective electrical grounding properties for different structural applications.

The front member 14, back member 16, first side 18 and the second side 20 can be such as, for example, black iron, aluminum, stainless steel, galvanized steel, hot-rolled steel, cold-rolled steel or the like. Additionally, novel material compositions may incorporate nano-enhanced composites, graphene-infused metals, or conductive polymer-metal hybrids that provide enhanced grounding capabilities while maintaining structural requirements. In certain embodiments, the front member 14, back member 16, first side 18 and the second side 20 can be telescopic allowing the user to set the desired length and width of the frame. The front member 14, the back member 16, the first side 18 and the second side 20 can be multiple pieces with a locking member allowing them to slide in and out of each other allowing the user to set and lock in the desired length.

In certain embodiments, the front member 14, back member 16, first side 18, and second side 20 can each comprise multiple interconnecting segments designed with overlapping sections that facilitate telescopic movement. These segments can incorporate various locking mechanisms to secure the desired dimensional configuration such as, for example, spring-loaded pins, threaded compression fittings, cam-lock devices, electronically controlled latching systems or the like. The locking mechanisms can be designed to maintain both mechanical stability and electrical conductivity across the telescopic joints. The telescopic mechanism may incorporate linear bearing systems, precision-machined sliding surfaces, or low-friction composite materials to ensure smooth operation and maintain electrical continuity throughout the adjustment range.

The telescopic segments may additionally incorporate visual or digital measurement indicators, allowing precise adjustment to predetermined dimensions. The sliding interfaces between segments can feature conductive contact elements, ensuring consistent electrical properties regardless of the extended position. The telescopic members can also include internal channeling for routing additional grounding conductors or monitoring sensors while maintaining the adjustable functionality. The system can have automated or semi-automated adjustment mechanisms, allowing remote or programmed dimensional changes based on environmental conditions or specific grounding requirements which can be such as, for example, motorized actuators, shape-memory alloy drivers, or other advanced positioning systems integrated within the telescopic members while maintaining the essential grounding functionality of the frame structure.

In embodiments, the grounding mat system 10 can comprise an integrated mesh structure formed by a plurality of first members 26 oriented in a first direction intersecting with a plurality of second members 28 oriented perpendicular to the first members. The resultant mesh configuration can be coupled to the frame 12 at least one connection point 32. The mesh structure and frame 12 can be coupled together through at least one connection point 32 distributed across the assembly, wherein these connection points can utilize various joining technologies such as, for example, welding processes, structural adhesive systems incorporating conductive elements, cold spray metal deposition techniques, mechanical fastening, high-temperature soldering processes, or the like.

The grounding mat system 10 can further comprise a plurality of first members 26 oriented in a first direction coupled to a plurality of second members 28 oriented perpendicular to the first members forming a continuous mesh network mesh that can coupled to the frame 12 in at least one connection point 32. The plurality of first members 26 and the plurality of second members 28 can be such as, for example, square steel wire mesh grid #4, bar stock, flat stock, or the like and can be a square, rectangular, circular, polygonal mesh shape. In the preferred embodiment, the mesh can be 6 inch by 6 inch square. The plurality of first members 26 and the plurality of second members 28 can be one piece or can be multiple pieces coupled together by such as, for example, weld, coupling, braze, solder, adhesive or the like.

In other embodiments, the plurality of first members 26 and the plurality of second members 28 can be multiple pieces that overlap each other and are coupled together at least one connection node 30. The mesh geometry can be dynamically varied based on soil conductivity mapping, featuring zones of increased density where higher ground current dissipation is required. In other embodiments, the system 10 can have integrated soil conditioning chambers at strategic locations, allowing for the controlled release of conductivity-enhancing compounds to maintain optimal grounding performance over time. Each connection point or intersection point can incorporate microscopically engineered surface texturing that increases effective contact area and reduces connection impedance under varying environmental conditions.

In certain embodiments, the grounding mat system 10 can have intelligent monitoring capabilities through distributed sensing nodes integrated within the mesh structure. These nodes comprise micro-electromechanical systems (MEMS) that continuously monitor ground current distribution, soil moisture content, and electrical impedance variations across the mat surface. The system can have electrochemically-activated polymer coatings on the conductive members 26, 28 that automatically adjust their conductivity based on environmental conditions, providing adaptive ground path optimization. Strategic points within the mesh incorporate phase-change materials encapsulated in corrosion-resistant chambers, which maintain thermal stability during high-current events while simultaneously acting as sacrificial anodes to protect the primary structure.

The at least one connection points 32 can have advanced composite materials with gradient conductivity properties, transitioning from highly conductive cores to corrosion-resistant outer layers. The at least one connection point 32 can have shape-memory alloys that automatically adjust connection pressure based on thermal conditions, ensuring optimal contact resistance regardless of environmental variations. The system 10 can have selective areas of magnetic field manipulation through engineered ferrite structures, creating preferred paths for high-frequency fault currents while maintaining low impedance at power frequencies.

In embodiments, the plurality of first members 26 and the plurality of second members 28 can be coupled to at least on of the front member 14, the back member 16, the first side 18 and/or the second side 20 by at least one connection point 32 by such as, for example, weld, solder, adhesive, mechanical coupling, fasteners, or the like. The plurality of first members 26 and the plurality of second members 28 can create an equipotential zone for a lineman or work to stand on while working on an electrical system. The system 10 can further comprise a grounding rod 50 having a first end 52 and a second end 54 wherein the first end is coupled to the mesh and the second end is coupled to a ground of the structure 72. The grounding rod 50 can be coupled to the mesh or the plurality of first members 26 and the plurality of second members 28 by such as, for example, weld, fastener, adhesive, solder, mechanical attachment or the like. The grounding rod 50 second end 54 can be coupled to the structure 70 by such as, for example, weld, connector, compression fitting, solder, fastener, or the like.

In certain embodiments, the grounding rod 50 connection can incorporate bi-metallic transition zones with graduated conductivity profiles, thermally-responsive coupling elements that automatically adjust contact pressure under varying conditions, and integrated corrosion monitoring sensors. The mesh network creates a precisely controlled equipotential zone optimized for personnel safety during high-voltage operations, featuring adaptive current distribution patterns that respond to varying soil conditions and fault scenarios.

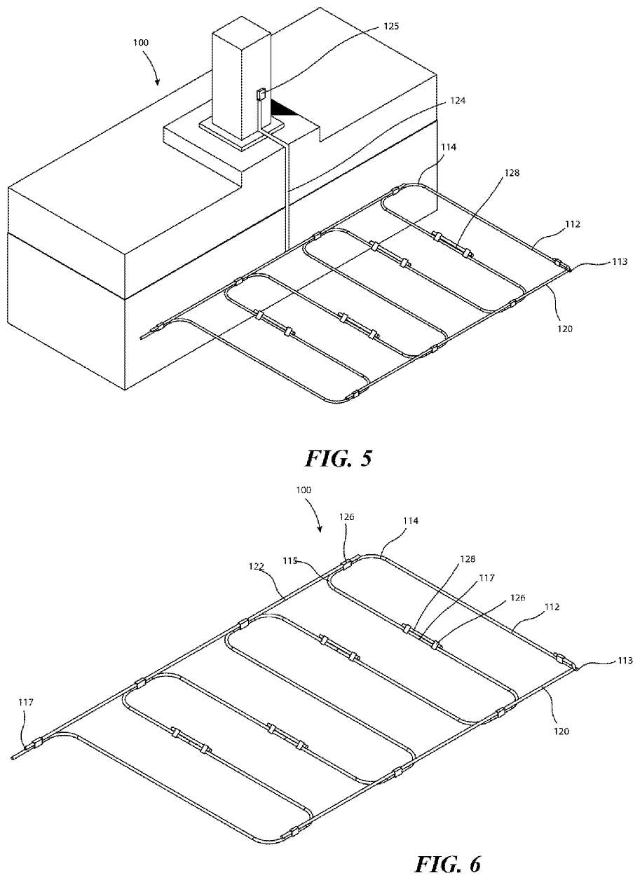

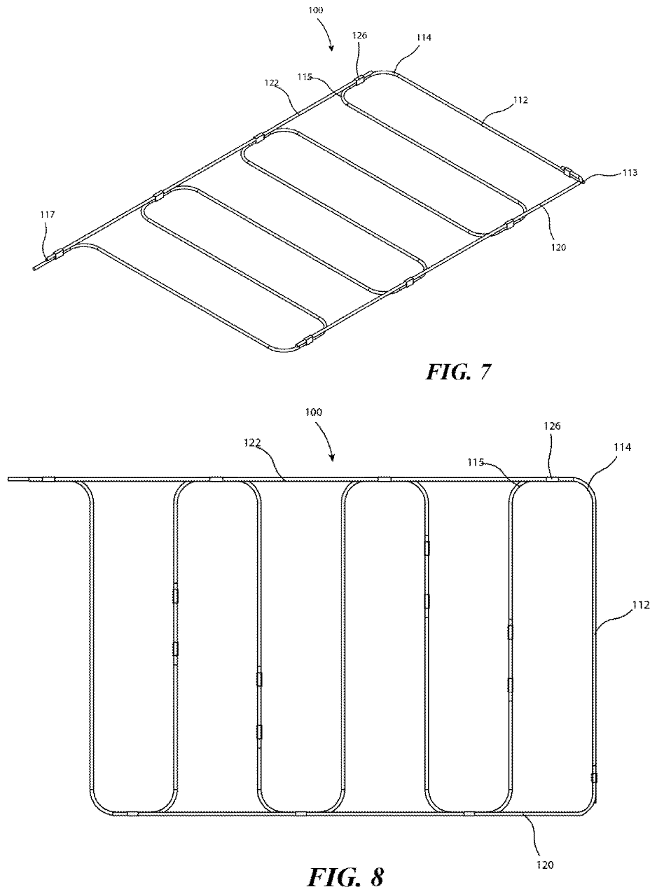

Referring to FIG. 5-8, a grounding system 100 comprises at least one first rod 112 having a first end 113 and a second end 117. The first rod 112 extends from the first end to a first bend 114, then perpendicularly to a second bend 15, creating a repeating geometric pattern. The pattern can form U-shaped, V-shaped or a mesh section extending over a user-specified length, as shown particularly in FIG. 7.

The system 100 can have connection blocks 126 that facilitate coupling between multiple rod components. These connection blocks 126 include at least one hole configured to receive the first rod 112, a second rod 120, a third rod 122, and/or a fourth rod 128. The connection blocks 126 may be manufactured from conductive materials including copper, silver, steel, or similar materials, and support various connection methods including welding, crimping, and bonding. The system 10 can have adjustable spacing between sections, which can range from approximately 0.5 inches to 144 inches, allowing precise adaptation to specific voltage requirements. The first bend 114 and second bend 115 may be formed with radii ranging from 0 degrees to 180 degrees, providing additional installation flexibility.

The rod components, including the first rod 112, second rod 120, third rod 122, and fourth rod 128, may be constructed from various materials including wire mesh, flat steel, round steel, copper wire, or ground rod material. The system 10 can allow for either continuous rod construction from the first end 113 to the second end 117, or modular assembly using multiple sections joined by connection blocks 126. A grounding rod 124 couples to either the first rod 112, second rod 120, or third rod 122, and connects to the structure's ground 125, completing the grounding pathway. The third rod 120 extends substantially near the first end 113 and couples to the first rod 112 and at least one section, providing additional grounding pathways.

In operation, the system's geometric configuration and modular construction enable optimized grounding performance while accommodating various installation requirements. The multiple connection points and adjustable spacing allow for precise tuning of the grounding system's electrical characteristics, while the variety of supported materials and connection methods provides cost-effective implementation options. The improved grounding system offers several advantages over conventional designs, including enhanced adaptability, simplified installation, and optimized performance across different voltage specifications. The modular nature of the system also facilitates maintenance and modifications, providing a more versatile and practical solution for electrical grounding applications.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A grounding system for electrically grounding a structure with voltage comprising:
a front end, back end, first side and a second side coupled together forming a frame having a top side and a bottom side;
a plurality of first members oriented in a first direction coupled to a plurality of second members oriented perpendicular to the first members forming a mesh that is coupled to the frame in at least one connection point; and
a grounding rod having a first end and a second end wherein the first end is coupled to the mesh and the second end is coupled to a ground of the structure.

2. The system according to claim 1, wherein the mesh is coupled to the frame in a plurality of locations wherein the at least one connection point is a weld between the first member and the second member and the top side or bottom side.

3. The system according to claim 1, wherein the plurality of first members is coupled together by either overlapping the first and second members and welding or welding the plurality of first members to the plurality of second members at each junction.

4. The system according to claim 1, wherein the plurality of first members and the plurality of second members are made from copper or steel.

5. The system according to claim 1, wherein the frame is black iron.

6. The system according to claim 1, wherein the front end, back end, first side and second side are coupled together by a plurality of welds.

7. The system according to claim 1, wherein the structure is place on earth wherein grounding system is placed in the earth by at least 2 feet to 4 feet.

8. The system according to claim 1, wherein the grounding rod is made from copper, stainless steel, or copper plated bar.

9. A grounding system for electrically grounding a structure with voltage comprising:
at least one first rod having a first end wherein the at least one rod can extend from the first end to a first bend wherein the first rod extends perpendicular to a second bend wherein the at least one rod can extend horizontal from the second bend repeating at least once creating a plurality of sections from the first rod;
a second rod extending substantially near the first bend and coupled to the first rod;
a third rod extending from substantially near the first end and coupled to the first rod; and
a grounding rod coupled to either the at least one first rod, the second rod or the third rod.

10. The grounding system according to claim 9, wherein the at least one first rod can be coupled together by a fourth rod creating multiple sections by a connection block wherein the connection block has at least one hole for the at least one first rod and the fourth rod.

11. The grounding system according to claim 10, wherein the at least one first rod can be welded to the connection block and the fourth rod can be welded to the connection block.

12. The grounding system according to claim 11, wherein the second rod and third rod can be welded to the top and bottom of the at least one first rod in at least one location by the connection block.

13. The grounding system according to claim 12, wherein the connection block is made from copper or steel.

14. The grounding system according to claim 11, wherein the at least one first rod, second rod, third rod and fourth rod are wire mesh, flat steel, round copper, copper round bar, round steel, copper wire, or ground rod.

15. The grounding system according to claim 11, wherein the connection block can be coupled to the at least one first rod, second rod, third rod and fourth rod by weld, crimp, or bonding.

16. The grounding system according to claim 11, wherein the at least one first rod are multiple sections that are welded together with the connection block and at least one second or third rod or is one continuous rod from the first end to a second end.

17. The grounding system according to claim 9, wherein the first bend and the second bend are 90-degree radius.

18. The grounding system according to claim 10, wherein the grounding rod is coupled to the ground of the structure.
